(19) United States
(12) Patent Application Publication
(10) Pub. No.: US 2013/0035814 A1
(43) Pub. Date: Feb. 7, 2013

(54) ELECTRICAL CHARGING SYSTEM THAT INCLUDES VOLTAGE-CONTROLLED OSCILLATOR WHICH OPERATIVELY CONTROLS WIRELESS ELECTROMAGNETIC OR WIRELESS INDUCTIVE CHARGING OF A BATTERY

(71) Applicants: Richard J. Boyer, Mantua, OH (US); Brian D. Pasha, Cortland, OH (US); John Victor Fuzo, Corland, OH (US)

(72) Inventors: Richard J. Boyer, Mantua, OH (US); Brian D. Pasha, Cortland, OH (US); John Victor Fuzo, Corland, OH (US)

(73) Assignee: DELPHI TECHNOLOGIES, INC., Troy, MI (US)

(21) Appl. No.: 13/564,754

(22) Filed: Aug. 2, 2012

Related U.S. Application Data
(60) Provisional application No. 61/515,865, filed on Aug. 6, 2011.

(51) Int. Cl. B60L 11/00; H02J 7/00

(52) U.S. Cl. 701/22; 320/108; 903/903

(57) ABSTRACT

An electrical charging system (ECS) is used to electrically charge an energy storage device (ESD) using wireless electromagnetic or inductive charging. The ECS includes a voltage-controlled oscillator (VCO) electrical circuit, a first transducer, and a plurality of second transducers. The VCO electrical circuit sequentially excites a plurality of coils in a first transducer to select one of a plurality of second transducers in which to transfer energy when the ESD is electrically charged. ECS power efficiency is measured during the excitation of the plurality of coils and used to determine whether the ECS uses the electromagnetic or inductive approach to electrically charge the ESD. The VCO electrical circuit also assists to maintain an optimum ECS power efficiency during electrical charging of the ESD. A method to electrically charge an ESD associated with a first vehicle and an ESD associated with a second vehicle with the ECS is also presented.

### RELATED DOCUMENTS

This application claims priority to provisional application U.S. Ser. No. 61/515,865 filed on 6 Aug. 2011.

### TECHNICAL FIELD

This invention relates to an electrical charging system used to electrically charge a battery of a vehicle, more particularly, an electrical charging system includes provisions to selectively use either wireless electromagnetic transmission or inductive wireless transmission to electrically charge a battery disposed on the vehicle.

### BACKGROUND OF INVENTION

It is known to use an electrical charging system that only utilizes wireless magnetic energy transmission to electrically charge a battery. It is also known to use an electrical charging system that only utilizes wireless inductive energy transmission to electrically charge a battery. Generally, the batteries being electrically charged are disposed in hybrid electric or electric vehicles which assist to power a drivetrain of these vehicles.

Hybrid electric vehicles and electrical vehicles continue to gain acceptance and commercial success with consumers in the marketplace. With a plethora of electrical charging systems being brought to the consumer market, many charging stations may be undesirably needed at energy distribution locations in the marketplace to ensure electrical charging convenience for consumers. This adds undesired complexity and increased cost to the overall commercial electrical charging system infrastructure.

Thus, what is needed is a robust electrical charging system that simplifies the electrical charging system infrastructure, ascertains the type of wireless electrical charging system that is associated with a vehicle, and then subsequently electrically charges the correct vehicle at an electrical charging system frequency that produces optimum electrical charging system power efficiency.

### SUMMARY OF THE INVENTION

An electrical charging system (ECS) is utilized to electrically charge a plurality of energy storage devices (ESDs), or batteries disposed on a plurality of vehicles using a wireless transmission mechanism that is selectably determined, or matched to the vehicle configured for electrical charging. The ECS uses a VCO electrical circuit to assist in this selectable determination. After the wireless transmission mechanism has been determined and the battery is being electrically charged, the VCO electrical circuit is also used to maintain an optimum system power efficiency of the ECS during the electrical charging process of the battery.

A method to electrically charge a battery disposed on a first vehicle or a battery disposed on a second vehicle is also presented. The method includes a step that determines which vehicle to electrically charge using a VCO electrical circuit that sequentially and/or iteratively excites a plurality of coils of an off-vehicle transducer and further analyzes the system power efficiency of the ECS during these excitations of the plurality of coils to assess which wireless transmission mechanism to employ to effectively electrically charge the battery.

Further features, uses and advantages of the invention will appear more clearly on a reading of the following detailed description of the embodiments of the invention, which are given by way of non-limiting example only and with reference to the accompanying drawings.

### BRIEF DESCRIPTION OF THE DRAWINGS

This invention will be further described with reference to the accompanying drawings in which:

FIG. 1 is a block diagram view of an electrical charging system (ECS) that includes a voltage-controlled oscillator (VCO) electrical circuit in accordance with the invention;

FIG. 2 is a more detailed block diagram of the ECS of FIG. 1 disposed intermediate the battery and the on-vehicle transducer;

FIG. 3 shows a block diagram view of the VCO electrical circuit of FIG. 1;

FIG. 4 shows an angular phase difference relationship between voltage and electrical current that is monitored by the VCO electrical circuit of FIG. 3;

FIG. 5 shows a method to electrically charge an energy storage device (ESD) of a first vehicle and an ESD of the second vehicle with the ECS of FIG. 1; and

FIG. 6 shows a VCO electrical circuit of an ECS according to an alternate embodiment of the invention.

### DETAILED DESCRIPTION OF THE EMBODIMENTS OF THE INVENTION

A resonant frequency of an electrical charging system (ECS) may vary due to variation in loading, variation electrical component performance due to tolerance stack-ups, variation in temperature, variation in component placement and orientation. Variations may also result if an off-vehicle transducer is frequency-tuned for one particular on-vehicle transducer and then used for a different on-vehicle transducer that is not tuned to the same frequency or range of frequencies. One or many of these kinds of variation may undesirably reduce operating system power efficiency of the ECS. It has been discovered that ECS power efficiency may be effectively managed and controlled in relation to the aforementioned variations while also allowing the opportunity to electrically charge an energy storage device (ESD) using a plurality of energy transmission arrangements. These energy transmission arrangements are selectable in part by utilization of a voltage-controlled oscillator (VCO) electrical circuit disposed in the ECS. Usage of the VCO electrical circuit in the ECS advantageously provides for the electrical charging of ESDs disposed in multiple vehicle types using a plurality of wireless transmission modes. These features combine to advantageously allow simplification of the commercial electrical grid so that one ECS may be configured to electrically charge many different vehicles in a manner that is similar to a grade of liquid combustible fuel being usable for many fuel-based motorized vehicles operatively driven in today's marketplace.

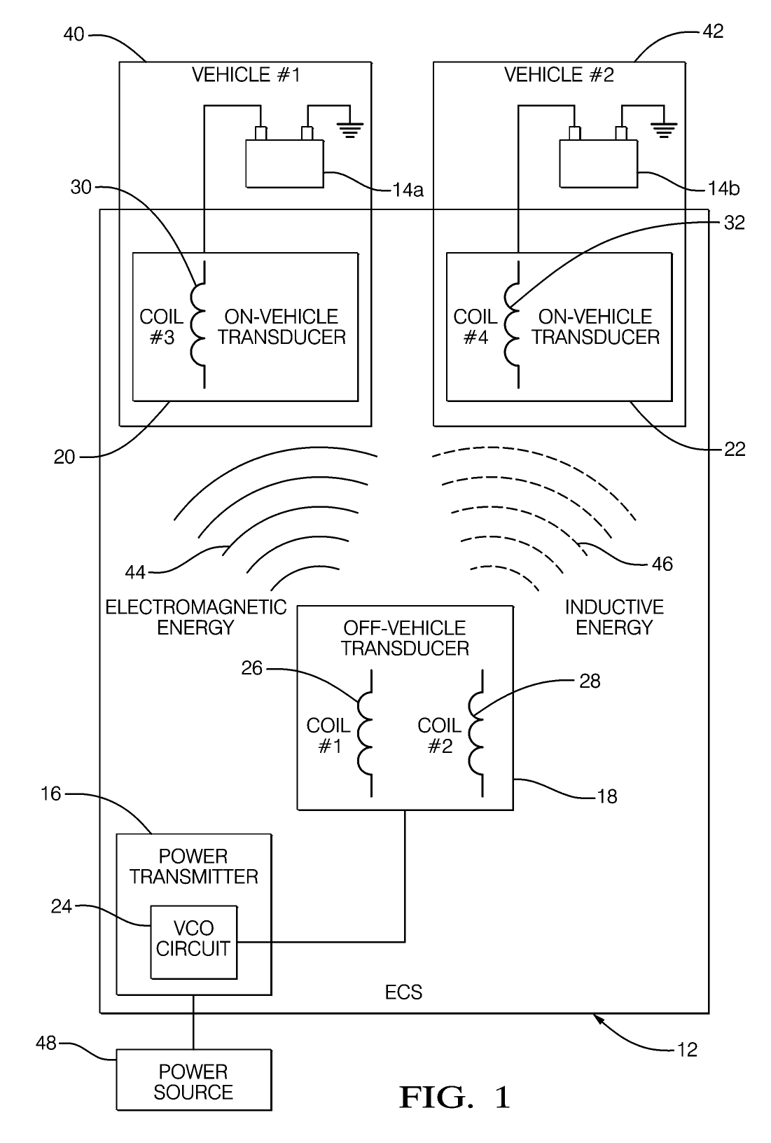

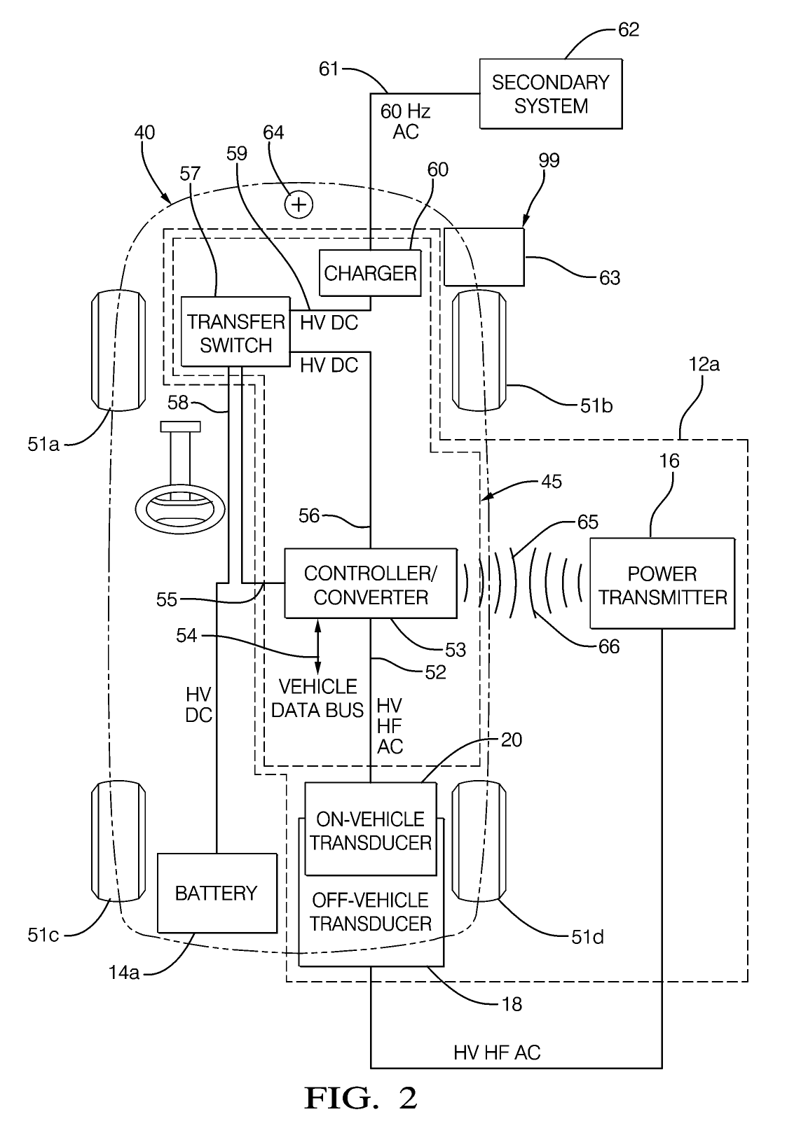

To this end, and referring to FIGS. 1 and 2 and in accordance with a one embodiment of this invention, an ECS 12 is presented that is effective to electrically charge a variety of ESDs 14a, 14b. ESD 14a is disposed on a vehicle #1, or first motorized vehicle 40. ESD 14b is disposed on a vehicle #2, or second motorized vehicle 42. First vehicle 40 and second vehicle 42, respectively, may be a hybrid vehicle or a hybrid electric vehicle. ESD 14a, 14b are configured to power a drivetrain of respective first vehicle 40 and second vehicle 42 such that these vehicles movingly travel down a road. The drivetrain communicates with the wheels of these vehicles so that the vehicle may movingly travel along the road. As such, one or both of these vehicles may be further categorized as pluggable hybrid electric vehicles (PHEVs), pluggable electric vehicles (PEVs), or extended range electric vehicles (EREVs). ECS 12 includes a power transmitter 16, an off-vehicle transducer 18, and a plurality of on-vehicle transducers 20, 22. Power transmitter 16 further includes a voltage-controlled oscillator (VCO) electrical circuit 24. Power transmitter 16 is disposed external to first vehicle 40 and disposed external to second vehicle 42. Off-vehicle transducer 18 includes coil #1, or first coil 26 and coil #2, or second coil 28. First coil 26 and second coil 28 are in electrical communication with VCO electrical circuit 24. Preferably, off-vehicle transducer 18 is configured for being secured to a ground surface (not shown). On-vehicle transducer 20 is attachingly disposed on first vehicle 40 includes coil #3, or third coil 30. On-vehicle transducer 22 is attaching disposed on second vehicle 42 includes coil #4, or fourth coil 32. Each on-vehicle transducers 20, 22 may be attached the vehicle. In one embodiment, the on-vehicle transducers may respectively attach to a vehicular support frame of the first vehicle and the second vehicle using any type of fastener as is known in the art. The location of the on-vehicle transducers on the first vehicle and the second vehicle may be along any portion of the undercarriage along the respective length of the first vehicle and the second vehicle.

First coil 26, when excited with energy supplied by power transmitter 16, wireles sly transmits magnetic, or electromagnetic energy 44 to third coil 30. The electromagnetic energy transmission is a first wireless energy transmission mechanism. Second coil 28, when excited with energy supplied by power transmitter 16, is wirelessly transmits inductive energy 46 to fourth coil 32. The inductive energy transmission is a second wireless energy transmission mechanism. For electrical charging of batteries 14a or 14b, respective on-vehicle transducers 20, 22 are spaced apart from off-vehicle transducer 18. Thus, first and second coil 26, 28 are respectively separated by a distance from third coil 30 and fourth coil 32. Further, third coil 30 of on-vehicle transducer 20 is in electrical communication with battery 14a of first vehicle 40 and fourth coil 32 of on-vehicle transducer 22 is in electrical communication with battery 14b of second vehicle 42.

Transmission of energy between coils 26, 30 and coils 28, 32 depends on the alignment of these respective coils so that energy may be wireless transferred therebetween. Such an alignment of coils may be realized when at least a portion of an on-vehicle coil overlies an off-vehicle transducer. Referring to FIG. 2, at least a portion of on-vehicle transducer 20 overlies off-vehicle transducer 18. Alternately, the on-vehicle transducer may not overlie the off-vehicle transducer, yet still be proximate the on-vehicle transducer so that wireless energy transmission occurs therebetween. Also referring to FIG. 2, generally one vehicle, and hence one on-vehicle transducer, will operate with the off-vehicle transducer within a given period of time. Thus, both the ESD of the first vehicle and the ESD of the second vehicle would not be electrically charged by the ECS within the same time period. For example, as best illustrated in FIG. 2, ESD 14a disposed on first vehicle 40 is configured for electrical charging by ECS 12.

Power transmitter 16 is in electrical communication with power source 48. Power source 48 may supply voltage of 120 VAC or 240 VAC that is generally associated with a power grid. Power source 48 may also have an operating frequency such as 50 Hertz (Hz) or 60 Hz. Alternately, the power source may have an operating voltage that differs from 120 VAC or 240 VAC or an operating frequency that differs from 50 Hz or 60 Hz.

VCO electrical circuit 24 controls a single driving frequency or a single driving frequency within a range of frequencies that is electrically transmitted to the off-vehicle transducer 18 to either/or first coil 26 or second coil 28. It should be understood that a frequency to drive first coil 26 may be different than the frequency needed to drive second coil 28. It should also be understood that vehicles 40, 42 represent a subset of many different types of vehicles that may be used in the marketplace that would benefit from ECS 12 where ECS 12 also allows the flexibility to wireles sly transmit electromagnetic or inductive energy to electrically charge these different vehicle types.

The following definitions described below apply to FIG. 2. Several definitions below are for terms that are denoted on signal paths illustrated in FIG. 2.

HV HF AC—A high voltage, high frequency alternating current (AC) electrical signal. Preferably, the voltage signal is greater than 120 VAC and the frequency of the voltage signal is greater than 60 Hertz (Hz). The frequency may be in a range of 10 kHz to 450 kHz. For example, this range may cover wireless inductive transmission that generally is in a range from 10-70 kHz and wireless electromagnetic transmission generally in a range of 50-450 kHz.

HV DC—A high voltage, direct current (DC) electrical signal. Preferably, the DC voltage is greater than 120 VDC.

60 Hz AC—A 60 Hz, AC voltage electrical signal. Generally, the AC voltage is either 120 VAC or 240 VAC dependent on the power source generating the voltage. Secondary system 62 supplies a 60 Hz AC voltage to electrically charge the battery. Alternately, the 60 Hz may be 50 Hz, AC voltage electrical signal.

120 VAC or 240 VAC, 60 Hz—A 120 VAC or 240 VAC, 60 Hz electrical signal. For example, this may be an electrical signal supplied by the power source to the primary system (240 VAC) or the secondary system (120 VAC, plug-in). The primary and/or the secondary system may be hardwired or pluggable to these power sources dependent on the electrical application of use.

Electrical Charge System (ECS) Power Efficiency—Also known as system power efficiency. The amount of power input relative to the amount of power output of the ECS. Typically, the system power efficiency may have a range from0% to 100% with 100% being totally efficient with no loss of power between the input and the output. For some electrical applications it may be desired to have the highest system power efficiency as possible thereby having a percentage value closer to 100%. The system power efficiency may be affected by a number of factors one of which is the electrical components used to construct the ECS which may affect the power loss through the ECS. Also, the system power efficiency is affected by the frequency of operation of the ECS. This allows the VCO electrical circuit to fine tune, control, and optimize the system power efficiency.

Transducer—The on-line transducer and the off-line transducer altogether include first coil 26, second coil 28, third coil 30, and fourth coil 32. A device that converts energy from one form to another. For example, an off-vehicle transducer converts electrical energy to electromagnetic energy or inductive energy and the on-vehicle transducer receives at least a portion of the electromagnetic energy or the inductive energy and then converts this received electromagnetic or inductive energy back to electrical energy that may be used to electrically charge the battery.

Power Source—This is power supplied by an electrical power grid such as is supplied by a power municipality. The high power primary ECS electrically connects to a power source. A conventional 60 Hz ECS also electrically connects with a power source. Preferably, the power source in electrical connection with the high power ECS has a greater voltage than the power source in electrical communication with the 60 Hz ECS. Alternately, the 60 Hz may be 50 Hz.

While ECS 12 includes power transmitter 16 with VCO electrical circuit 24, off-vehicle transducer 18, on-vehicle transducer 20 as previously discussed herein, ECS 12 also extends in this non-limiting example to include and enhanced primary ECS 12a that includes controller/convertor 53, integrated charger 60, and transfer switch 57. Controller/convertor 53, integrated charger 60, and transfer switch 57 are disposed on vehicle 40 and operatively perform with power transmitter 16 with VCO electrical circuit 24, off-vehicle transducer 18, and on-vehicle transducer 20 to provide electrical current that is useful to electrically charge ESD 14a. Controller/converter 53, integrated charger 60, and transfer switch 57 comprise electrical components that form at least one electrical signal shaping device (ESSD) 45.

Thus, power transmitter 16 is in electrical communication with, and is configured to provide energy to off-vehicle transducer 18. Being secured to the ground surface, off-vehicle transducer 20 is disposed external to vehicle 40. On-vehicle transducer 20 is configured to receive at least a portion of the energy wireles sly transmitted from off-vehicle transducer 18. ESSD 45 is in electrical communication with on-vehicle transducer 20 to electrically shape at least a portion of the received energy and electrically transmit the electrically-shaped energy to electrically charge ESD 14a.

A secondary ECS 62 may also electrically communicate with integrated charger 60 to provide a 60 Hz electrical current to charge battery 14a. Secondary ECS 62 advantageously provides another alternative mode to electrically charge battery 14a for enhanced convenience for a human operator of enhanced primary ECS 12a and secondary system 62. Transfer switch 57 is operatively controlled by a controller portion of controller/converter 53 via signal line 55 to switch between secondary ECS 62 and primary ECS 12. An output 52 carries an electrical signal produced by on-vehicle transducer 20 is received by a converter portion of controller/converter 53. An output 56 that carries an electrical signal from the converter portion of controller/convertor 53 is received by transfer switch 57. An output 58 carries an electrical signal from transfer switch 57 to battery 14a. A vehicle communications data bus 54 communicates with the controller portion of controller/convertor 53 to receive/transmit either vehicle data information to ECS 12a or ECS data to other electric devices disposed within vehicle 40. Vehicle 40 includes wheels 51a, 51b, 51c, 51d that assist to align vehicle so on-vehicle transducer 40 is in alignment with off-vehicle transducer 18. An alignment means 99, such as a wheel chock 63 may further assist in this alignment of the transducers 18, 20. Also, an alignment device 64, may also assist to position vehicle 40 so transducers 18, 20 are aligned. Such an alignment device may include a tennis ball hanging from a ceiling of a garage, for example. Alignment is needed for energy transmission to occur from the off-vehicle transducer to the on-vehicle transducer. As shown in FIG. 2, alignment of transducers 18, 20 may be where at least a portion of on-vehicle transducer 20 overlies off-vehicle transducer 18, as best illustrated in FIG. 2. Alternately, alignment of the transducers may be where the transducer are sufficiently spaced apart, but allow for wireless transmission of energy to occur therebetween such that the battery of the vehicle is electrically charged. Secondary system 62 produces an output 61 that carries an electrical signal received by charger 60 and charger produces an output 59 that carries an electrical signal that is received by transfer switch 57. The controller portion of controller/converter wirelessly communicates with power transmitter 16 and power transmitter 16 is configured to wirelessly communicate with the controller portion of controller/convertor 53.

A first frequency of a first electrical current input to controller/convertor 53 of primary ECS 12a has a greater frequency value than a second frequency of a second electrical current carried on output 61 from secondary ECS 62. Thus, ECS 12a may apply more power to electrically charge battery 14a than secondary ECS 62. The controller portion of controller/convertor 53 measures voltage, current, and power. The controller portion of controller/converter 53 transmits the measured voltage, current, and power data to power transmitter 16 such that power transmitter 16 may further regulate the amount of power supplied to off-vehicle transducer 18 to ensure optimum ECS power efficiency. Preferably, optimum ECS power efficiency is greater than 85% Likewise, power transmitter 16 may further wireles sly transmit supplied power data to the controller portion of the controller/converter 53. The instant controller/configuration previously describe herein along with other ESSD configurations are further described in U.S. Ser. No. 13/450,881 entitled “ELECTRICAL CHARGING SYSTEM HAVING ENERGY COUPLING ARRANGEMENT FOR WIRELESS ENERGY TRANSMISSION THEREBETWEEN, filed on Apr. 19, 2012, which is incorporated by reference herein. While FIG. 2 depicts ECS 12 associated with first vehicle 40, second vehicle 42 may have a similar ECS configuration which wireles sly transmits/receives inductive energy 46. Alternately, the second vehicle may have an ECS electrical configuration that is different from the first vehicle as depicted in FIG. 1. For example, the ECS associated with the second vehicle may be another ECS configuration as described in U.S. Ser. No. 13/450,881, as previously described herein.

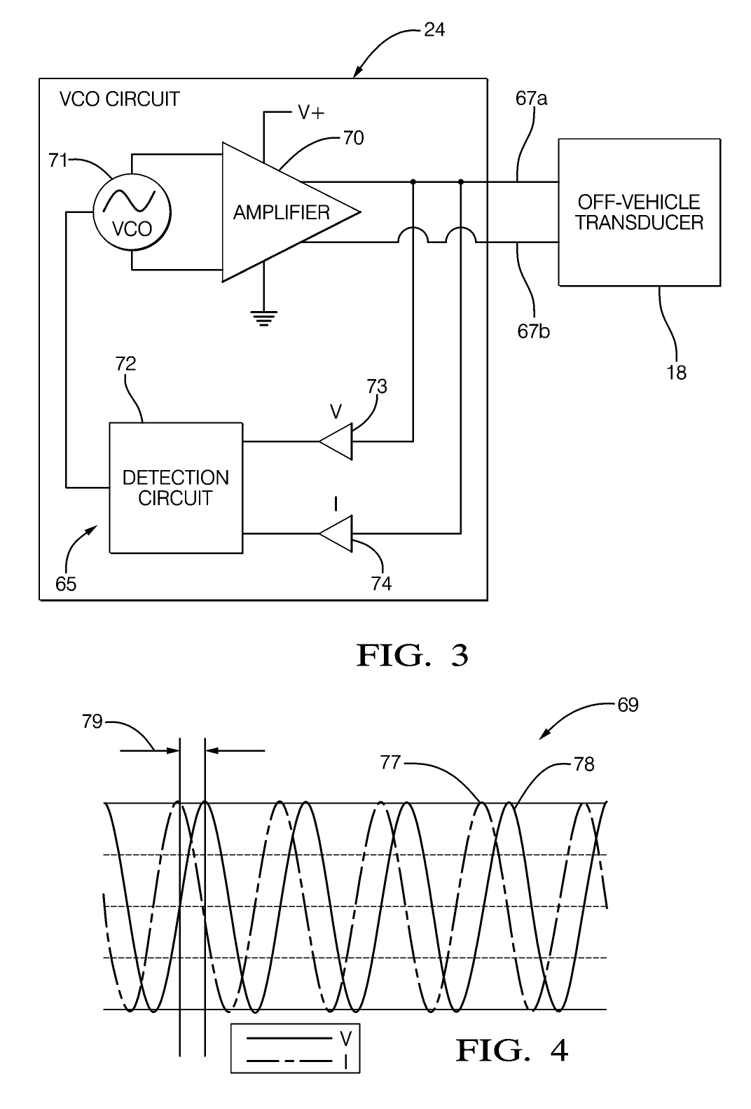

Referring to FIG. 3, a block diagram of the VCO electrical circuit 24 is shown. VCO circuit 24 includes a VCO 71, an amplifier 70, a voltage monitor 73, a current monitor 74, and a detection circuit 72. VCO 71 is in electrical communication with inputs of amplifier 70. First, VCO 71 is effective to assist ECS 12 to know which vehicle 40, 42 is in need of electrical charging. This is done by sweeping the frequency range covered by coil pair 26, 30 and coil pair 28, 32 and determined which on-vehicle transducer coil 30, 32 is energetically excited. Second, VCO 71 then assists to manage the supplied power from power transmitter 16 to off-vehicle transducer 18 for coil 26 or coil 28 for the determined energized pair of coils 26, 30 or 28, 32. Generally, as previously described herein, only the first vehicle's on-vehicle transducer or the second vehicle's on-vehicle transducer will be aligned with the off-vehicle transducer at any given time. A typical situation arises for this scenario when the human occupant positions their vehicle in the garage to electrically charge the battery. The outputs of amplifier 70 are in electrical communication with off-vehicle transducer 18. A feedback loop 65 is produced intermediate off-vehicle transducer 18 and VCO 71. Feedback loop 65 includes a voltage monitor 73 and a current monitor 74 in electrical communication with a detection circuit 72. Voltage monitor 73 monitors and measures the voltage flow at the input to off-vehicle transducer 18 and current monitor 74 monitors and measures the electrical current flow at the input to off-vehicle transducer 18. Detection circuit 72 is advantageous to measure the phase difference between the voltage and the electrical current at the input to off-vehicle transducer 18. Detection circuit 72 is electrically coupled with a VCO 71 which controls the frequency of the current received from power source 48 to supplied to output 67a. Detection circuit 72 is sufficiently formed from electronic components that work together to determine if the received voltage and electrical current waveforms are within a predetermined phase difference range. Detection circuit 72 is designed to operate with predetermined, or predefined electrical component tolerances of the ECS and system tolerances of the ECS, particularly the component tolerances of on-vehicle transducers 20, 22 and off-vehicle transducer 18. Additional tolerances to incorporate in the overall component tolerances are electrical circuitry that supports VCO circuit 24. Thus, detection circuit 72 is designed in a manner to incorporate the design tolerances of coils #1-#4 26, 28, 30, 32 along with operational tolerances of coil pairs 26, 30 and 28, 32.

Further, ECS 12 monitors AC voltage and AC electrical current of the RF power supplied to an off-vehicle transducer 18 from power transmitter 16 for determining if the frequency is at an optimal value to produce a desired ECS power efficiency. Such an optimal value will be determined by the variation of the specific electrical components of the ECS. If the frequency is not optimal this information is fed back to the RF power source and the frequency is varied to realize optimal performance. The monitoring of output voltage and current is done continuously during the charging cycle and resonant frequency correction is applied as needed by the ECS. The AC voltage and AC current are monitored and measured by voltage monitor 73 and current monitor 74. The phase relationship between the AC voltage and the AC current is determined by the ECS between. Power transmitter 16 then adjusts the power supplied to the off-vehicle transducer 18 to ensure the ECS power efficiency is maintained at a desired level. In one embodiment, the preferred ECS power efficiency is at least 85%. Preferably, the operational frequency range of the VCO circuit is from about 15 kHz to 200 kHz.

Referring to FIG. 4, a graph 69 illustrates an example of an AC current flow measurement 77 and a AC voltage measurement 78 as a function of time in output line 67a, 67b of VCO circuit 24 of power transmitter 16. Current flow measurements 77 and voltage measurements 78 are sine waves that are out of phase by an amount represented by an angular phase difference, or phase differential 79. If phase differential 79 falls outside a predetermined range in relation to the ECS power efficiency, detector 72 provides a signal to adjust the output frequency power transmitter 16. For the wireless electromagnetic energy transfer between first coil 26 and third coil 30 the angular phase difference is preferably in a range from about 10 degrees to about 15 degrees to ensure optimum ECS power efficiency performance of the ECS. The angular phase difference takes into account the effects of part tolerances, temperature, and the alignment of the coils. When the ECS operates at a higher ECS power efficiency, the more efficient the utilization of energy so that the operator of the ECS is able to operate the ECS with less cost. Thus, the design of the ECS including the VCO electrical circuit determines if the voltage and the current waveforms are within a predetermined phase difference range that ensures the ECS power efficiency delivered to the battery is at an optimum level. The predetermined phase difference range and the ECS power efficiency are analyzed by the ECS, more specifically by the controller in the VCO electrical circuit so that an optimum level of the ECS power efficiency is maintained. After analysis of the voltage and current waveforms input to the off-vehicle transducer, the controller outputs a voltage that is operable to adjust the frequency in the VCO electrical circuit so the output signal of the power transmitter to the off-vehicle transducer maintains the desired ECS power efficiency. This also ensures the voltage and current phase difference is maintained at about 15 degrees for electromagnetic transmission between the first coil and the third coil and at zero (0) degrees for inductive transmission between the second coil and the fourth coil. Thus, the ECS uses the system power efficiency measurements during the excitation of the first and second coils and the angular phase difference value to assist in making a decision if the first vehicle needs electrical charging or if the second vehicle needs electrical charging.

ECS 12 is not in use when power transmitter 16 is not in electrical communication with power source 48.

ECS 12 is partially in use when power transmitter 16 is in electrical communication with power source 48, but ECS 12 is not operational to electrically charge either battery 14a or battery 14b.

ECS 12 is in use when ECS 12 is electrically charging either battery 14a or battery 14b. To this end, coils 26, 30 or coils 28, 32 must be sufficiently disposed close enough so that wireless transmission of electromagnetic 44 or inductive 46 energy occurs therebetween as previously described herein.

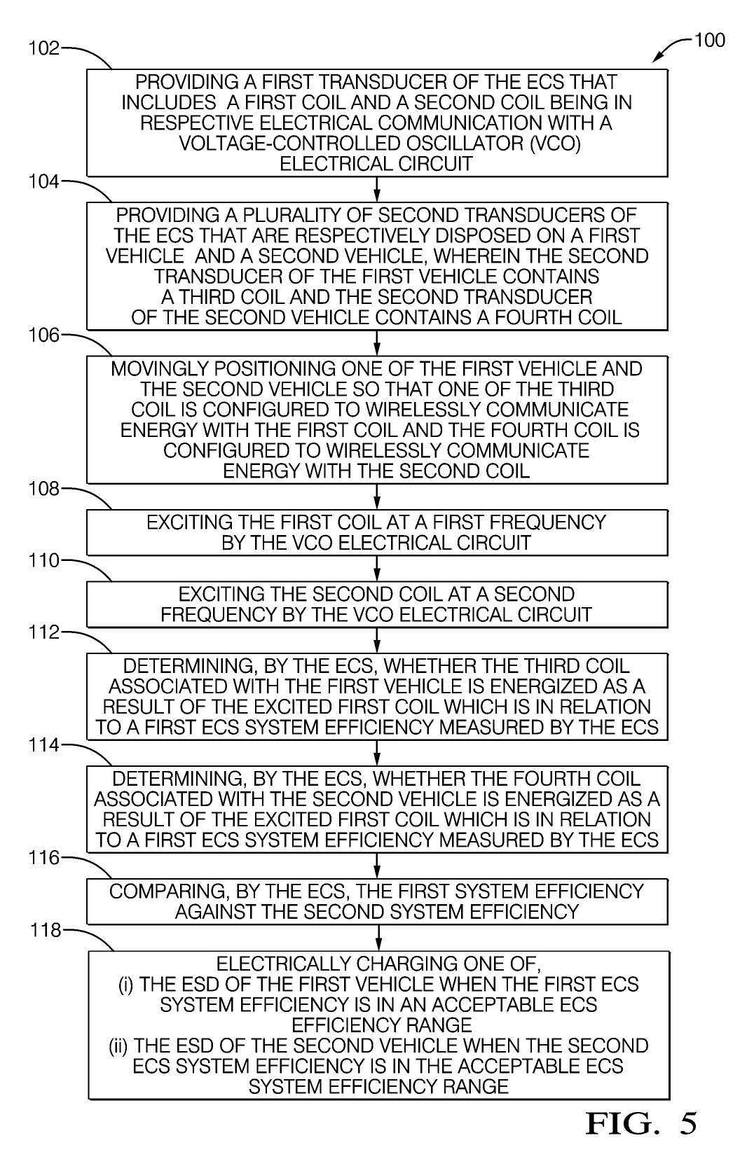

Referring to FIG. 5, in one non-limiting example of operationally using ECS 12, a method 100 to electrically charge ESD 14a of first vehicle 40 and an ESD 14b of second vehicle 42 with ECS 12 will now be described. One step 102 in method 100 is providing first transducer 18 of ECS 12 that includes first coil 26 and second coil 28. First coil 26 and second coil 28 are in respective electrical communication with VCO electrical circuit 24 of ECS 12. Another step 104 in method 100 is providing a plurality of second transducers 20, 22 of ECS 12 that are respectively disposed on at least first vehicle 40 and second vehicle 42. Second transducer 20 associated with first vehicle 40 contains third coil 30 and second transducer 22 associated with second vehicle 42 contains fourth coil 32. A further step 106 in method 100 is movingly positioning one of first vehicle 40 and second vehicle 42 such that one of third coil 30 is configured to wirelessly communicate energy with first coil 26 and fourth coil 32 is configured to wirelessly communicate energy with second coil 28. Another step 108 in method 100 is exciting first coil 26 of first transducer 18 at a first frequency by VCO electrical circuit 24. A further step 110 of method 100 is exciting second coil 28 of first transducer 18 at a second frequency different from the first frequency by VCO electrical circuit 24. Another step 112 in method 100 is determining, by ECS 12, whether third coil 30 associated with first vehicle 40 is energized as a result of excited first coil 26 which is in relation to a first ECS power efficiency measured by ECS 12 when first coil 26 is excited in exciting step 108. A further step 114 in method 100 is determining, by ECS 12, whether fourth coil 32 associated with second vehicle 42 is energized as a result of excited second coil 28 which is in relation to a second ECS power efficiency measured by ECS 12 when second coil 28 is excited in exciting step 110. Another step 116 in method 100 is comparing, by ECS 12, the first ECS power efficiency against the second ECS power efficiency. A further step 118 in method 100 is electrically charging either ESD 14a of first vehicle 40 when the first ECS power efficiency is in an acceptable ECS power efficiency range or electrically charging ESD 14b of second vehicle 42 when the second ECS power efficiency is in the acceptable ECS power efficiency range. The excitation of first and second coil 26, 28 may be an iterative process to understand which vehicle's battery needs to be electrically charged.

Additionally, the frequency of the VCO electrical device may be varied to match the phase angle difference of the AC voltage and AC current of the output of the VCO electrical circuit as previously described herein. Thus, the VCO circuit's output frequency is adjusted based on the phase angle difference in relation to the optimum ECS power efficiency.

While not directly affecting the frequency of ECS 12 as adjusted by VCO electrical circuit 24 a number of factors further affect whether ECS 12 operatively electrically charges ESD 14a of first vehicle 40 or electrically charges ESD 14b of second vehicle 42. Any one of these factors or all of these factors may affect whether the ECS operates to electrically charge the ESD. One factor is the state of health of the ESD of the first vehicle or the ESD of the second vehicle. Another factor is the level of electrical charge of the ESD of the first vehicle or the ESD of the second vehicle. A further factor is the on/off state of the ECS. The ECS may have a push-button for ECS on/off control disposed on the power transmitter that is depressible by a human operator of the ECS. Additionally, these factors are monitored by the ECS. For example, if the state of health of the ESD is such that the ESD is not healthy, the ECS would not electrically charge the ESD. In another instance if the ECS determines that the level of electrical charge of an ESD is at a full level of electrical charge, the ECS would not electrically charge the ESD. If the push-button of the ECS is not depressed to activate the ECS for electrical charging, the ECS would not electrically charge the ECS.

It should be noted that the angular phase difference values are predetermined to be in a predetermined range of values that correspond to a range of predetermined frequencies associated with the wireless transmission mechanisms (i.e. wireless electromagnetic and wireless inductive) as previously described herein. Thus, VCO electrical circuit 24 outputs one of the frequencies to one of the coils 18, 26, and then ECS 12 measures the system power efficiency and determines if it is in acceptable range. If so, VCO electrical circuit 24 fine tunes the frequency of the electrical signal output from power transmitter 16 to off-vehicle transducer 18 until the optimum system power efficiency of ECS 12 is obtained. VCO electrical circuit 24 continues to monitor the angular phase difference values and adjust frequency by VCO electrical circuit 24 to maintain the optimum system power efficiency throughout the electrical charging of the ESD. If, however, the first frequency was not in the acceptable range, then the VCO electrical circuit 24 outputs another known frequency corresponding to another wireless transmission mechanism and starts the process over of determining if the system power efficiency is in an acceptable range for the outputted frequency. If the system power efficiency is in acceptable range then VCO electrical circuit fine tunes to ensure optimum system power efficiency during the charge cycle. If the system power efficiency is not in the acceptable range, the VCO tries yet another frequency in what may be an iterative process to properly electrically charge first vehicle 40 or second vehicle 42.

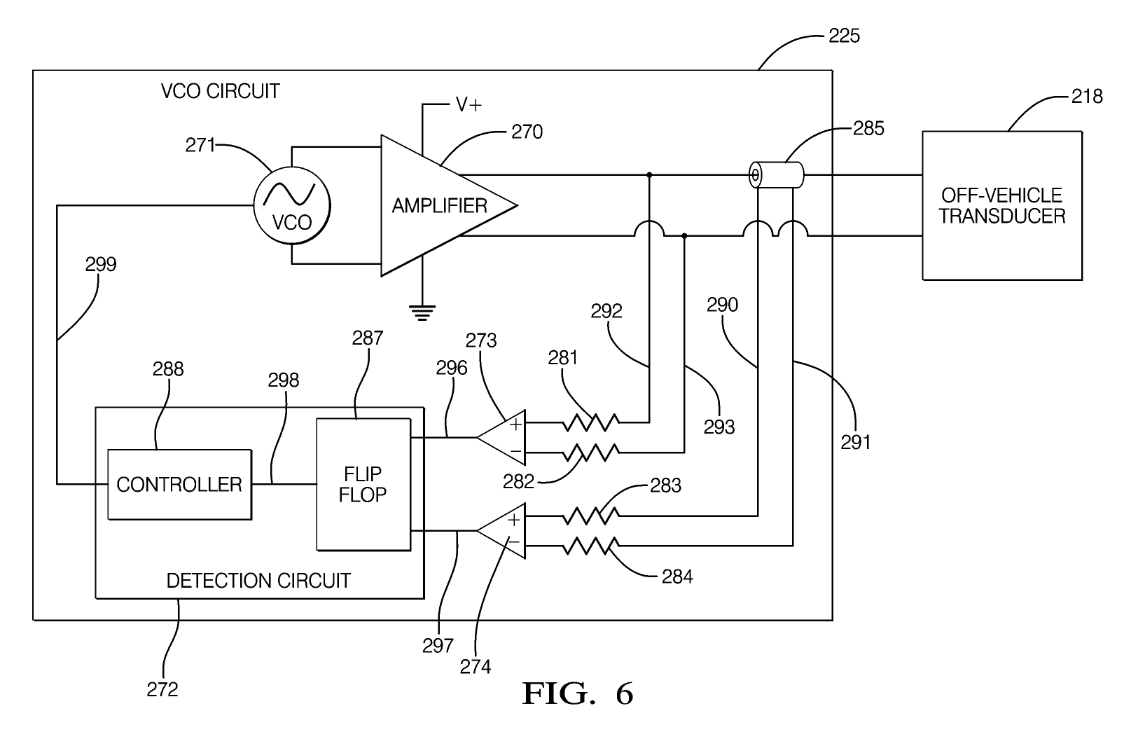

Referring to FIG. 6, according to an alternate embodiment of the invention, a VCO electrical circuit 225 is illustrated. Similar elements in relation to VCO circuit 24 of FIG. 3 that are shown in FIG. 6 have reference numerals that differ by 200. Similar to the VCO circuit 24 as previously described herein, VCO circuit 225 employs a VCO 271, an amplifier 270, a voltage monitor 273, an electrical current monitor 274, and a detection circuit 272. Detection circuit 272 includes a flip-flop electrical component 287 and a controller 288. Flip-flop 287 provides a number of counts to controller 288 that allow controller 288 to determine what voltage to provide on output 299 to operatively control the frequency of VCO 271. Resistors 281-284, 289 allow the electrical signals to be biased at the correct voltage level. Current monitor 274 is electrically connected to a coil 285 that provides a current sense from an output of an amplifier 270. VCO 271 is in electrical communication with inputs of amplifier 270. Voltage electrical signals are carried on signal paths 292, 293 and received by voltage monitor 273. Electrical current signals are carried on signal paths 290, 291 and received by current monitor 274. Flip-flop electrical component 287 receives an output 296 from voltage monitor 273 and an output 297 from current monitor 274. An output 298 of flip-flop electrical component 287 is received by controller 288. VCO 271 receives an output 299 from controller 288. For example, if a zero electrical pulses are output from the flip flop to the controller no adjustment in the frequency of the VCO electrical circuit may be necessary. If the number of pulses on the output of the flip flop is greater than zero pulses due to the feedback of monitors 273 and 274 voltage adjustment to the VCO may occur that is in relation to the amount of received feedback signal.

Alternately, other predetermined phase angle difference values may be employed for the electromagnetic transmission and the inductive wireless transmission dependent on the electrical application of use for the ECS. In some applications, for instance, with may require an optimal phase angle difference of 21 degrees for the wireless electromagnetic transmission and an optimal phase angle difference of 2 degrees for the wireless inductive transmission. Still alternately, the phase difference angle may be any value that is determined dependent on the application of use of the ECS.

Alternately, the spirit and scope of the invention may also apply to any other wireless transmission type other than electromagnetic and inductive transmission, such as electric field coupling for example.

Still alternately, the detection circuit of the VCO electrical circuit may comprise an embedded controller. Such a circuit implementation, for example, may eliminate other electrical blocks/electrical components in the VCO electrical circuit simplifying the circuit design that may have decreased cost. Referring to FIG. 3, using an embedded controller allows incorporated functionality so that monitors 73, 74, detection circuit 72, and VCO electrical device 71 may not be needed. Similarly, referring to FIG. 7, monitors 273, 274, flip-flop 287, controller 288 and VCO electrical device 271 may not be needed when an embedded controller is used in the VCO electrical circuit.

Thus, a robust electrical charging system that simplifies the electrical charging system infrastructure, ascertains the type of wireless electrical charging system that is associated with a vehicle, and then subsequently electrically charges the correct vehicle at an electrical charging system frequency that produces optimum electrical charging system power efficiency has been presented. In addition, the ECS may be configured to wirelessly transmit electromagnetic or inductive energy across a distance between an off-vehicle transducer and an on-vehicle transducer. A VCO electrical circuit is conveniently manufactured in a power transmitter of the ECS that supplies the off-vehicle transducer. The VCO electrical circuit is used to both determine whether the vehicle being electrically charged is a electromagnetic system or a inductive system and then assists to effectively manage the frequency of the electrical signal so that optimal ECS power efficiency is maintained during the electrical charging of the battery of the vehicle that contains the electromagnetic or inductive ECS. The ECS is constructed of electrical components such as resistors, capacitors, relays, and the like, that are commonly commercially available in the electrical arts. The VCO electrical device may be purchased as commonly available part at the frequencies of interest covered by the electromagnetic and inductive wireless mechanisms of the ECS. The detection circuit of the VCO electrical circuit may be easily constructed with a flip-flop electrical component and a controller. ECS 12 conveniently determines the system power efficiency during the exciation of the first and the second coil and also whether a phase difference relationship exists, either a 15 degree relationship or a zero (0) degree relationship, to know whether the first vehicle's on-vehicle transducer or the second vehicle's on-vehicle transducer is in alignment with off-vehicle transducer. A 15 degree phase difference angle is discovered to provide a definitive value for determination of an electromagnetic ECS arrangement.

While this invention has been described in terms of the preferred embodiment thereof, it is not intended to be so limited, but rather only to the extent set forth in the claims that follow.

It will be readily understood by those persons skilled in the art that the present invention is susceptible of broad utility and application. Many embodiments and adaptations of the present invention other than those described above, as well as many variations, modifications and equivalent arrangements, will be apparent from or reasonably suggested by the present invention and the foregoing description, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the following claims and the equivalents thereof.

We claim:

1. An electrical charging system (ECS) to electrically charge at least one energy storage device (ESD), comprising:
a voltage-controlled oscillator (VCO) electrical circuit;
a first transducer that includes a plurality of coils that at least contain a first coil and a second coil in respective electrical communication with the VCO electrical circuit;
a plurality of second transducers that respectively include at least one of,
(i) a third coil, and
(ii) a fourth coil,
wherein when the VCO electrical circuit operates at a first frequency the first coil wirelessly communicates with the third coil to electrically charge the ESD, and when the VCO electrical circuit operates at a second frequency different from the first frequency the second coil wireles sly communicates with the fourth coil to electrically charge the ESD.

2. The ECS according to claim 1, wherein the plurality of second transducers are disposed on a plurality of vehicles which include a first motorized vehicle and a second motorized vehicle, and the first motorized vehicle includes a second transducer in the plurality of second transducers that contains the third coil and the second motorized vehicle includes a second transducer in the plurality of second transducers that contains the fourth coil.

3. The ECS according to claim 2, wherein the first vehicle and the second vehicle, respectively, are one of an electric vehicle and a hybrid electric vehicle and the ESD of the first vehicle is configured to power a drivetrain of the first vehicle and the ESD of the second vehicle is configured to power a drivetrain of the second vehicle.

4. The ECS according to claim 2, wherein the VCO electrical circuit is disposed in a power transmitter associated with the ECS, and said power transmitter is disposed external to the first vehicle and disposed external to the second vehicle.

5. The ECS according to claim 1, wherein the third coil wirelessly receives electromagnetic energy from the first coil and the fourth coil wirelessly receives inductive energy from the second coil.

6. The ECS according to claim 5, wherein the VCO electrical circuit operatively maintains an angular phase difference for said electromagnetic energy and an angular phase difference for said inductive energy, said angular phase difference for one of said electromagnetic energy and said inductive energy being between an AC voltage in relation to an AC electrical current that are respectively output from a power transmitter associated with the ECS and respectively received as inputs by the first transducer.

7. The ECS according to claim 6, wherein said angular phase difference for said electromagnetic energy has a value in range from about ten (10) degrees to about fifteen (15) degrees and said angular phase difference for said inductive energy has a value that is about zero (0) degrees.

8. The ECS according to claim 1, where in the VCO electrical circuit includes,
an amplifier having an input and an output, said output being in electrical communication with the first transducer,
a VCO electrical device in electrical communication with the input of the amplifier,
a voltage monitor electrical circuit having an input in electrical communication with the output of the amplifier,
a current monitor electrical circuit having an input in electrical communication with the output of the amplifier, and
a detection electrical circuit having an output and a first input and a second input, wherein
said output of the detection electrical circuit is in electrical communication with an input of the VCO electrical device, and
said first input of the detection electrical circuit receives an electrical signal from the voltage monitor electrical circuit, and
said second input of the detection electrical circuit receives an electrical signal from the current monitor electrical circuit.

9. The ECS according to claim 8, wherein said detection electrical circuit further includes a controller in electrical communication with said VCO electrical device.

10. A method to electrically charge an energy storage device (ESD) of a first vehicle and an ESD of a second vehicle with an electrical charging system (ECS), comprising:
providing a first transducer of the ECS that includes a first coil and a second coil, the first coil and the second coil being in respective electrical communication with a voltage-controlled oscillator (VCO) electrical circuit of the ECS;
providing a plurality of second transducers of the ECS that are respectively disposed on at least the first vehicle and the second vehicle, wherein the second transducer associated with the first vehicle contains a third coil and the second transducer associated with the second vehicle contains a fourth coil;
movingly positioning one of the first vehicle and the second vehicle such that one of the third coil is configured to wirelessly communicate energy with the first coil and the fourth coil is configured to wirelessly communicate energy with the second coil;
exciting the first coil of the first transducer at a first frequency by the VCO electrical circuit;
exciting the second coil of the first transducer at a second frequency different from the first frequency by the VCO electrical circuit;
determining, by the ECS, whether the third coil associated with the first vehicle is energized as a result of said excited first coil which is in relation to a first ECS power efficiency measured by the ECS when the first coil is excited in the exciting step;
determining, by the ECS, whether the fourth coil associated with the second vehicle is energized as a result of said excited second coil which is in relation to a second ECS power efficiency measured by the ECS when the second coil is excited in the exciting step;
comparing, by the ECS, said first ECS power efficiency against said second ECS power efficiency; and
electrically charging one of,
(i) the ESD of the first vehicle when the first ECS power efficiency is in an acceptable ECS power efficiency range, and
(ii) the ESD of the second vehicle when the second ECS power efficiency is in said acceptable ECS power efficiency range.

11. The method according to claim 10, wherein the determining step further includes the sub-step of,
determining a first angular phase difference in relation to said first power efficiency of the ECS between an AC voltage and an AC current that are respectively input to the first transducer when the first coil is excited, and
determining a second angular phase difference in relation to said second ECS power efficiency of the ECS between an AC voltage and an AC current that are respectively input to the first transducer when the second coil is excited.

12. The method according to claim 11, wherein said determined first angular phase difference is greater than said determined second angular phase difference.

13. The method according to claim 12, wherein said determined first angular phase difference is about 15 degrees and said determined second angular phase difference is about zero (0) degrees.

14. The method according to claim 10, wherein said energy wirelessly received by the third coil from the first coil of the first vehicle comprises wireless electromagnetic energy and said energy wireles sly received by the fourth coil from the second coil of the second vehicle comprises wireless inductive energy.

15. The method according to claim 10, wherein the third coil wirelessly receives energy from the first coil at a first frequency and the fourth coil wireles sly receives energy from the second coil at a second frequency that is different from the first frequency.

16. The method according to claim 15, wherein the first frequency is greater than the second frequency.

17. The method according to claim 10, wherein the determining steps further include operational control of the VCO electrical circuit by the ECS associated with electrical charging of one of the,
(i) the ESD of the first vehicle, and
(ii) the ESD of the second vehicle,
wherein said operational control of said VCO electrical circuit is further based on at least one of,
a) a state of health of the ESD of one of the first vehicle and the second vehicle,
b) a level of electrical charge of the respective ESD of one of the first vehicle and the second vehicle, and
c) an on/off state of the ECS.

18. The method according to claim 17, wherein said operational control of said VCO electrical circuit is based on,
a) the state of health of the ESD of one of the first vehicle and the second vehicle,
b) the level of electrical charge of the respective ESD of one of the first vehicle and the second vehicle, and
c) the on/off state of the ECS.

19. The method according to claim 10, wherein the VCO electrical circuit is disposed in a power transmitter associated with the ECS, and said VCO electrical circuit includes an amplifier in direct electrical connection with said first transducer, and said power transmitter is disposed external to the first vehicle and the second vehicle.

20. The method according to claim 10, wherein said first vehicle and said second vehicle, respectively, are one of,
(i) a hybrid electric vehicle, and
(ii) an electric vehicle.
